(19) United States
(12) Patent Application Publication
(10) Pub. No.: US 2009/0096692 A1
(43) Pub. Date: Apr. 16, 2009

(54) Flat Antenna System With a Direct Waveguide Access

(76) Inventors: Eduardo Motta Cruz, Saint Herblain (FR); Julien Sarrazin, Nantes (FR); Yann Mahe, Petit Mars (FR)

Correspondence Address: Blakely, Sokoloff, Taylor & Zafman, 1279 Oakmead Parkway, Sunnyvale, CA, 94085-4040, US

(21) Appl. No.: 12/085,006

(22) PCT Filed: Nov. 14, 2006
(86) PCT No.: PCT/EP2006/068430

§ 371 Date: May 13, 2008

(30) Foreign Application Priority Data
Nov. 14, 2005 (FR) 0511527

(51) Int. Cl. H01Q 21/06

(52) U.S. Cl. 343/771

(57) ABSTRACT

The invention relates to a flat antenna system (10) comprising at least one sub-network of radiating elements (a₁-a₄) arranged on the surface of a substrate superimposed on a ground plane (5), wherein each sub-network consists of a plurality or radiating elements (3) supplied by the sub-network (b₁-b₄) power supply line to which they are connected, a slit (F₁-F₄) is embodied in the ground plane (5) in front of each sub-network (b₁-b₄) power supply line, the system also comprises a power transmission line (G) which is arranged with respect to the ground plane in such a way that an electromagnetic coupling is formed between said power transmission line and each sub-network power supply line by means of the slit. Said invention is characterised in that the power transmission line is positioned in such a way that it extends at an angle to the sub-network power supply lines.

The field of the invention is that of telecommunication antennae and more particularly that of antennae for Hertzian beams (HF antennae).

The invention relates more precisely to a flat antenna for Hertzian beams powered by a wave guide.

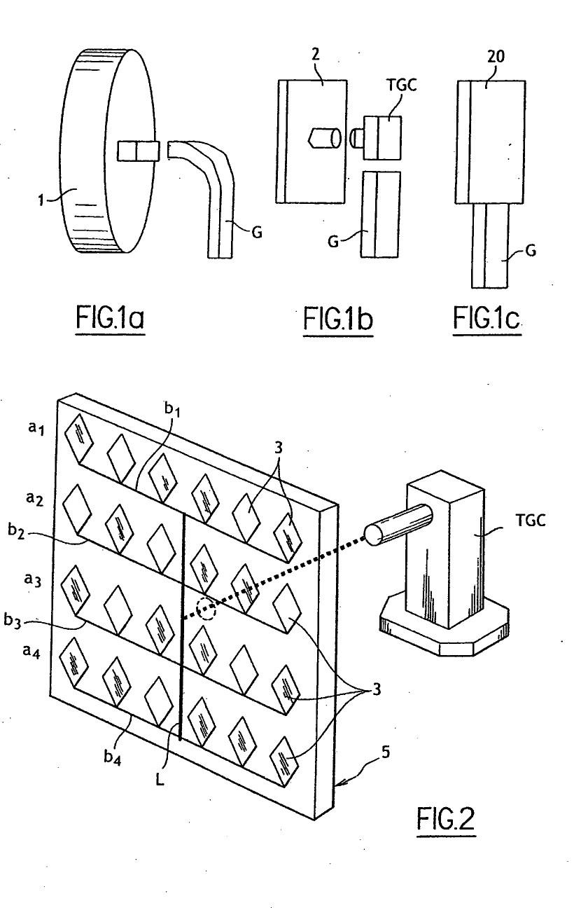

Satellite dishes are commonly used for Hertzian beams. A rectangular wave guide is generally connected to a housing offset to the rear of the satellite dish to create the electrical radio access of the antenna. FIG. 1a diagrammatically shows a satellite dish 1 connected to a wave guide G.

For equivalent surface areas, flat antennae are recognised as being just as efficient as satellite dishes. Flat antennae are further characterised by their compact size and low wind resistance (especially due to the fact they are thin) and thus tend to be preferred to satellite dishes.

One advantage of the printed technology used for flat antennae is its very good capacity to adapt to coaxial connections, for example of the SMA—3.5 mm type. As shown diagrammatically in FIG. 1b, it is thus possible to connect a flat antenna 2 equipped with a coaxial connector to a wave guide G by means of a coaxial-guide transition TGC.

Traditionally, and as shown in FIG. 2, the flat antenna 2 comprises a network of radiating elements integrated into the dielectric substrate of the antenna.

The antenna 2 comprises more precisely a set of linear sub-networks a₁-a₄ that are parallel to one another, wherein each linear sub-network a₁-a₄ is composed of a set of radiating elements 3. The radiating elements are typically each composed of a square conductive surface of which one corner is connected to a power line of a sub-network b₁-b₄ (typically in the form of a micro-strip).

FIG. 2 shows more precisely one embodiment of the power supply of a flat antenna 2 via a coaxial-guide transition TGC. For this purpose, a power supply line L (typically a micro-strip line) powered by the wave guide via a coaxial-guide transition TGC is fitted transversally to the linear sub-networks a₁-a₄. This power supply line L thus permits the power supply lines of sub-networks to be powered and consequently the radiating elements of all of the sub-networks.

The solution of FIG. 2 is not however entirely satisfactory.

Coaxial connections are in fact fragile and sensitive to galvanic sections. Furthermore, the micro-strip power supply line L has large linear losses, generally greater than the wave guide losses.

The prior art discloses, for example in the document U.S. Pat. No. 6,509,874, the addition of a slot in the earth plane opposite each sub-network power supply line and the fitting of a wave guide—in the form of a channel made on the surface of a metal body—with respect to the earth plane so that said guide extends perpendicularly to the sub-networks. In this way an electromagnetic coupling is created by the slot between said wave guide and each of the sub-network power supply lines.

However, with such an orthogonal set-up, the sub-networks are powered in opposite phase (every 180°). Therefore means are required to compensate the +/−180° of phase offset.

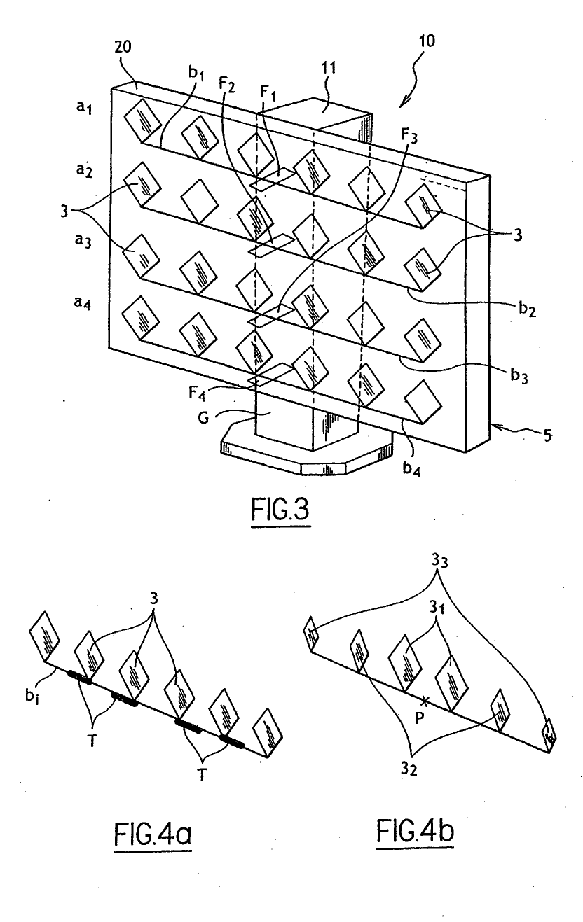

The document U.S. Pat. No. 6,509,874 thus shows (compare especially FIG. 3b) a sub-network power supply by slots in opposite phase, and phase correction achieved by moving the rows of radiating elements along the power supply line by an electrical length of +/−180°.

Another solution for phase correction is presented in the document U.S. Pat. No. 6,313,807 and consists of powering each network via one or the other sides of the wave guide.

The purpose of the invention is to propose a flat HF antenna that does not have the disadvantages related to the use of a coaxial guide transition, while permitting an equi-phase power supply of all the radiating elements of a same sub-network.

To this end, the invention proposes a flat antenna system comprising at least one sub-network of radiating elements located on a face of a substrate superposed on an earth plane, wherein each sub-network is composed of a plurality of radiating elements that may be powered by a sub-network power supply line to which they are connected, wherein a slot is made in the earth plane opposite each sub-network power supply line, wherein the system further comprises an energy transmission line positioned with respect to the earth plane so as to create one electromagnetic coupling per slot between said energy transmission line and each of the sub-network power supply lines, wherein the system is characterised in that the energy transmission line is fitted so that it extends obliquely with respect to the sub-network power supply lines.

Certain preferred but non restrictive aspects of this system are as follows:
the energy transmission line is a rectangular wave guide of which one face is in contact with the earth plane, and wave radiation slots are made in said face of the wave guide so that the slots in the earth plane and the slots of the wave guide are superposed;
the energy transmission line is a wave guide with a U shaped cross section, and said wave guide is fitted so that the earth plane closes off the wave guide space;
the energy transmission line is a three plate line comprising a conductor line sandwiched between two three-plate line earth planes, wherein wave radiation slots are made in the three-plate line earth plane that is in contact with said earth plane so that the slots of the earth plane and the slots of the three-plate line are superposed;
the energy transmission line is a three-plate line comprising a conductor line sandwiched between two three-plate line earth planes, and in that one of the three-plate line earth planes is combined with said earth plane;
the system comprises a plurality of linear sub-networks that are parallel to one another and in that the slots made in the earth plane are positioned vertically to the power supply lines;
the slots made in the transmission line are notches made obliquely in the length of the transmission line;
in the system, each power supply line is positioned with respect to the corresponding slot so as to control the coupling rate between the energy transmission line and said power supply line;
each sub-network power supply line comprises means of weighting the radiation amplitudes of the radiating elements of the sub-network;
radiating elements means comprise impedance transformers interspaced between the radiating elements;
the size of the radiating elements of a sub-network is weighted so as to weight the radiation amplitudes of said radiating elements;
weighting the size of a radiating element in the form of a conductive surface consists of reducing one of the characteristic dimensions of said surface; and
the power supply line of a sub-network of radiating elements is a micro-strip line.

Other aspects, purposes and advantages of this invention will become clearer upon reading the following description of preferred embodiments, provided by way of non restrictive example and made in reference to the appended drawings among which, apart from FIGS. 1a, 1b and 2 that have already been commented:

FIG. 1c shows diagrammatically a flat antenna with a direct wave guide access;

FIG. 3 shows a possible embodiment of a flat antenna system;

FIGS. 4a and 4b show different ways of weighting the amplitude of radiating elements;

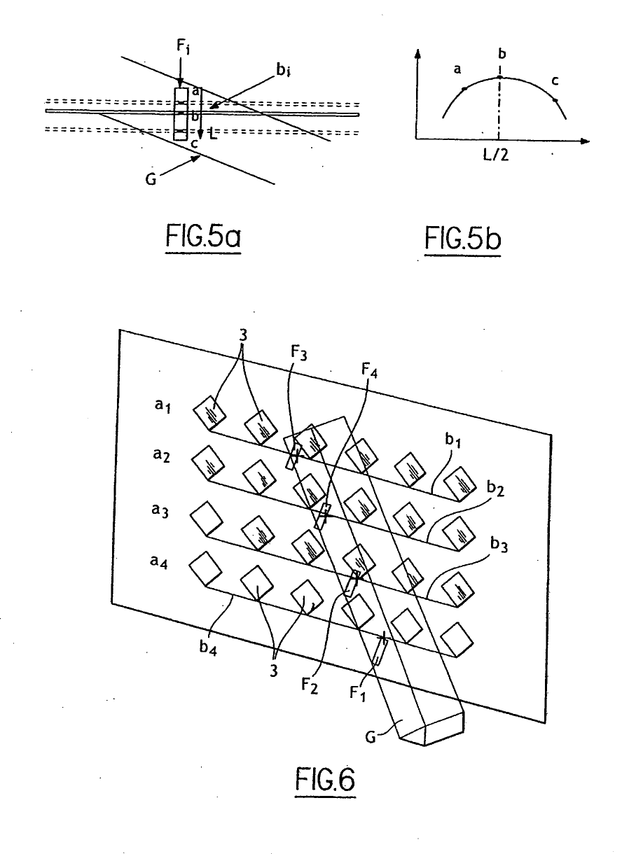

FIGS. 5a and 5b show the slot coupling between a wave guide and a power supply line according to the position of the line with respect to the centre of the slot;

FIG. 6 shows one advantageous embodiment of the flat antenna system according to the invention.

FIG. 1c shows very diagrammatically a flat antenna 20 with direct wave guide access G. FIG. 3 shows a possible embodiment of a flat antenna system 10. In this FIG. 3, the same elements used in common with FIG. 2 have been given the same references.

The system 10 comprises a flat antenna 20 and a wave guide G.

The flat antenna 20 traditionally comprises a flat conductive metal plate forming an earth plane 5 (shown in the background of FIG. 3) and a substrate in the form of a dielectric plate superposed and substantially parallel to the earth plate.

A circuit is printed onto the face of the substrate opposite the earth plane 5 and comprises radiating elements 3.

The antenna 20 comprises a set of linear sub-networks a₁-a₄ on the face of the substrate opposite the earth plane, that are parallel to one another, wherein each linear sub-network a₁-a₄ is composed of a set of radiating elements 3 that may be powered by a power line of a sub-network b₁-b₄. The power line is typically a micro-strip printed onto the same substrate or onto another layer.

The radiating elements are typically composed of a square conductive surface of which one peak is connected to the power supply line of the corresponding sub-network b₁-b₄, wherein the diagonal of the square starting from this peak is perpendicular to the corresponding power supply line b₁-b₄.

Of course, the invention is not restricted to a specific shape of radiating elements or to a specific connection to the corresponding power supply line.

The radiating elements may thus be formed by a conductive surface with a polygonal shape (for example a triangle or a rectangle) or even a circle.

The radiating elements may furthermore be powered at other points of the conductive surface than the peak of said surface, for example along one of the sides or even inside the conductive surface. In the last example, it is especially possible to open a “route” into the conductive surface by penetrating the power supply line into the conductive surface while leaving each side of the line of segments non-metallised.

A slot F₁-F₄ is made in the earth plane 5 opposite each power supply line of the sub-network b₁-b₄. The slots are preferably identical to one another. Each slot F₁-F₄ is thus positioned transversally to the corresponding power supply line.

When the sub-networks are linear sub-networks that are parallel to one another, then rectangular slots will be preferred positioned vertically with respect to the power supply lines.

The system 10 also comprises an energy transmission line G positioned with respect to the earth plane 5 so that an electromagnetic coupling per slot is created between said transmission line and each of the power supply lines of the sub-network.

The energy transmission line may be a wave guide or any other type of transmission line, especially a three-plate line.

The wave guide is for example a wave guide with a rectangular shaped section. It may also be a wave guide with a U shaped section.

The electromagnetic fields extend in the rectangular cavity of the wave guide from the bottom towards the top in the example of FIG. 3.

A terminal resistor (not shown) may be provided on an upper plate 11 of the wave guide G.

When the wave guide has a rectangular shaped section, wave radiation slots are made, identical to the slots in the earth plane, for example machined in the wave guide body, especially on one of the faces of the wave guide that is to be in contact with the earth plane 5 so that the slots of the earth plane and the slots of the wave guide are superposed (for these reasons, the same references have been used to designate all of the slots). The electromagnetic fields then extend in the guide space, via the superposed slots in the earth plane of the antenna and in the face of the wave guide in contact with the earth plane, and excite the power supply lines of the sub-networks.

When the wave guide has a U shaped section, the wave guide is fitted so that the earth plane 5 closes off the space of the wave guide. The electromagnetic fields then extend in the guide space via the slots in the earth plane of the antenna.

Of course, the antenna structure further comprises energy supply means for the transmission line (not shown), so as to provide electrical energy to said line, wherein this energy travels inside it and radiates via the slots F₁-F₄.

As already mentioned, the slots are made on a same face of the wave guide (when a rectangular wave guide is used) and said face is fitted opposite the earth plane of the antenna 20, on the opposite side to the dielectric substrate of the antenna. In this way, the access to the guide is attached to the earth plane of the antenna. The access is of course also attached to the earth plane when the latter closes off the space of the wave guide.

An energy supply line may also be provided in the form of a three-plate line comprising a conductive line sandwiched between two three-plate earth planes.

In a first variant, one of the three-plate earth planes is combined with the earth plane of the antenna (in which the slots are made).

In another variant, wave radiation slots are made in one of the three-plate earth planes that is in contact with the earth plane of the antenna so that the slots of the earth plane 5 and those of the three-plate line are superposed.

In the non-representative example of the invention in FIG. 3 (perspective view), the transmission line (shown here in the form of a wave guide but this also applies to the three-plate line embodiment) is fitted so that it globally extends perpendicularly to the power supply lines of the sub-networks. In such a case, the slots are made in the length of the transmission line (for example in the form of rectangular notches) so that they are positioned perpendicularly to the power supply lines.

Due to this coupling, an energy transfer occurs between the energy transmission lines which is to say between the wave guide or the three-plate line, on the one hand, and each of the sub-network power supply lines on the other hand. In this way, each sub-network power supply line is excited by the energy radiated by the slots and powers all of the radiating elements connected to this line.

Where the antenna structure of FIG. 2 provides for the power supply of the sub-networks of the radiating elements by a transversal power supply line L, the antenna structure according to the invention proposes to use a plurality of slots made so as to create an electromagnetic coupling between each sub-network and a portion of the energy transmission line, on the opposite side to the dielectric substrate of the antenna.

It may be noted that the document FR 2 646 565 proposes creating rectangular slots in a wave guide so that the energy spreads out in the guide so that it radiates directly towards the free space via the slots.

Contrary to the present invention, this document does not relate to the power supply of an antenna with a circuit on which radiating elements are printed, and therefore does not cover the power supply of such elements. This document furthermore in no way envisages using the slot radiation to create a coupling between two energy transmission lines, and especially a coupling of the wave guide with the power supply lines of radiating elements.

The flat antenna forms a network of radiating elements. In the absence of weighting of the amplitudes of the radiating elements, the level of the secondary lobes may reach around −13 dB.

The following description relates to two possible embodiments of the weighting of the amplitudes of the radiating elements of the flat antenna, especially permitting the level of the secondary lobes to be contained, for example to around −20 dB. It may be noted that these embodiments are not restricted to this invention for direct wave guide access by electromagnetic coupling by slots between the wave guide and the power supply lines of the sub-network. It may also be noted that these embodiments may be used separately or jointly.

In a first possible embodiment, as illustrated in FIG. 4a, the impedance transformers T are interspaced between the radiating elements 3 of a same sub-network in the power supply line of a sub-network bᵢ.

The transformers T are more precisely provided with transformation ratios which correspond to the progressive attenuations that are sought.

The transformers T are typically quarter-wave and half-wave transformers; transformers with progressive laws may also be used (for example exponential or logarithmic laws).

In a second possible embodiment, as illustrated in FIG. 4b, the weighting is “integrated” into the radiating elements 3 by varying the size of the surface of said elements.

In particular, the reduction of the surface of a radiating element is accompanied by the reduction of the energy transfer capacity from the radiating element to the outside, while conserving a same signal level however.

This second embodiment is advantageous as it permits the use of transformers to be avoided. The latter in fact produce discontinuities on the power supply line bᵢ of the sub-network. And these discontinuities in turn create parasite radiation that is partially responsible for the high levels of crossed components in plane H of the radiation diagram of the flat antenna (approximately −10 dB).

By carrying out such “integrated” weighting, the power supply line of the sub-network bᵢ no longer has the discontinuities related to the use of the transformers.

The various radiating elements 3 of the sub-network are then equi-weighted so that they are all powered identically by the power supply line bᵢ.

The radiating elements generally are in the form of square conductive plates, with a side/2 where the guided wave length on the printed circuit substrate on which the radiating elements are formed and which corresponds to the main radiation frequency of the antenna is represented.

As an example of the reduction in surface of an element, a radiating element may be considered that has the form of a rectangular conductive plate with a length/2 and a width/n, where n is greater than 2.

In other terms, in this case only one side of a square element is reduced. Conserving a side/2 in fact allows the main frequency to be conserved as the radiation frequency.

In general, this involves reducing one of the characteristic dimensions of the radiating element (one side in the case of a polygonal radiating element, the diameter in the case of a round radiating element).

As shown diagrammatically in FIG. 4b, the “integrated” weighting is preferably used by favouring the radiating elements 3₁ at the centre of the sub-network (with respect to the centre of excitation P of the power supply line of the sub-network in the centre of the line), and by progressively reducing the size of the radiating elements 3₂, 3₃ gradually when moving away from the point of excitation P, symmetrically with respect to the point P.

Returning to the description of the antenna structure of the invention, and according to one advantageous embodiment of the invention, the energy transfer between two transmission lines (between the wave guide or the three-plate line and a sub-network power supply line) is controlled, which is to say that the coupling rate is controlled, by adjusting the offset of the sub-network power supply line with respect to the centre of the slot.

As already mentioned, the slots are identical to one another (for example identical rectangular notches made both in the earth plane and in the rectangular section wave guide body) and it may be noted that the control of the coupling rate is carried out within the scope of the invention without adjusting the size of the slots (which is to say without providing different sizes of slots).

This coupling rate control is advantageous as it permits the compensation of the drop in power of the electromagnetic fields inside the wave guide (progressive drop towards a terminal end—upper plate 11 of the wave guide G—spreading out of the energy in the wave guide space) by progressively increasing the wave guide/sub-network power supply line incoming coupling rate (from the bottom towards the top in FIG. 3).

FIG. 5a shows a slot Fᵢ with a length L (in reality, two superposed slots when a rectangular section wave guide is used or even a three-plate line which has an earth plane in contact with the earth plane of the antenna) which excites a sub-network power supply line bᵢ. The prior art discloses that the distribution of currents along a slot with a half-wave length has its maximum value in the centre and drops towards the edges.

The coupling with a sub-network power supply line bᵢ positioned transversally with respect to the slot Fᵢ is therefore dependent on this current distribution law. Consequently, the further the line bᵢ is from the centre of the slot, the lower the coupling.

In FIG. 5a, three possible positions of the line bᵢ with respect to the slot Fᵢ are shown. The point b illustrates the case where the line bᵢ is positioned perpendicularly to the slot Fᵢ at the centre of the slot. Points a and c illustrate cases where line bᵢ is positioned perpendicularly to the slot Fᵢ and is offset with respect to the centre of the slot. In particular point c is more offset with respect to the centre of the slot than point b.

FIG. 5b shows the coupling rate between the slot and the power supply line according to the longitudinal position of the line with respect to the slot. It may be seen that the coupling is highest when the line bᵢ is positioned perpendicularly to the slot Fᵢ at the centre of the slot (point b). The coupling drops as the distance increases from the centre of the slot (compare points a and c; coupling at a is higher than at c).

FIG. 6 illustrates the advantageous embodiment of a flat antenna system of the invention in which the coupling rate is controlled between the energy transmission line and the various power supply lines. The transmission line (in this case the wave guide G) has a series of oblique slots F₁-F₄ and is positioned slightly obliquely with respect to the sub-network power supply lines so that the slots of the wave guides are superposed with the slots of the earth plane and are thus positioned perpendicularly to the power supply lines, while progressively varying, from one sub-network power supply line to another, the coupling rate between the wave guide and the power supply line.

In the example shown here, the coupling rate increases from one incoming sub-network power supply line to another (from the bottom to the top in FIG. 6). In FIG. 6, crosses have been used to indicate the position of each power supply line with respect to the corresponding slot. Initially, for the first slot from the wave guide input in the incoming direction, the cross is distant from the centre of the slot. The result is lower coupling.

Following the direction of the propagation of the energy in the wave guide, the cross progressively gets closer to the centre of the corresponding slot, and the coupling rate also increases progressively. On the last sub-network, the cross coincides with the centre of the corresponding slot, and the coupling rate is at maximum level.

The layout according to the invention of the wave guide positioned obliquely with respect to the sub-network power supply lines, as illustrated in FIG. 6, is further adapted to permit the powering of all of the radiating elements of a same sub-network with the same phase (equi-phase power supply).

The two types of transmission lines (wave guides and sub-network power supply lines) have different dielectric media. The wavelength in the substrate with low antenna losses is around 0.7 to 0.8 tiles the length of the wavelength in free space. The wavelength in free space itself is close to the wavelength in the wave guide.

In general, in order to avoid the possible strong rise in secondary lobes in the antenna radiation diagram, it is important to ensure that the difference between the radiating elements does not exceed 0.8 wavelengths in free space.

In the case of a linear network sub-network powered by a micro-strip line, said line, which has a length of 0.8 wavelengths in the space between two radiating elements, has an electrical length of one wavelength in the dielectric between two radiating elements, permitting all of the elements to be powered with the same phase.

Therefore, within the scope of the invention, as the wavelength in the guide is very close to that in a vacuum, positioning the wave guide obliquely with respect to the power supply lines of the sub-networks permits a difference of wavelength in a vacuum to be obtained, and consequently an equi-phased power supply between the sub-networks, while leaving a vertical space between the sub-network lines of approximately 0.8 wavelengths.

It may be noted that the oblique positioning is furthermore advantageous for machining oblique slots in the wave guide bodies (the power supply lines will thus be perpendicular to the slots, as is shown diagrammatically in FIG. 5a, which permits optimum distribution of the currents in the slots to be achieved, using electromagnetic field propagation modes inside the wave guides.

One application of the antenna system according to the invention relates to transmissions in the 22.1 to 23.1 GHz bands; however the invention is in no way restricted to this specific range of frequencies.

1. Flat antenna system (10) comprising at least one sub-network of radiating elements (a₁-a₄) positioned on a face of a substrate superposed on an earth plane (5), wherein each sub-network is composed of a plurality of radiating elements (3) that may be powered by a sub-network power supply line (b₁-b₄) to which they are connected, wherein a slot (F₁-F₄) is made in the earth plane (5) opposite each sub-network power supply line (b₁-b₄), wherein the system further comprises an energy transmission line (G) positioned with respect to the earth plane so as to create one electromagnetic coupling per slot between said energy transmission line and each of the sub-network power supply lines, and wherein the energy transmission line is fitted so that it extends obliquely with respect to the sub-network power supply lines.

2. System according to claim 1, wherein the energy transmission line is a rectangular wave guide (G) of which one face is in contact with the earth plane (5), and wherein wave radiation slots are made in said face of the wave guide so that the slots in the earth plane and the slots of the wave guide are superposed.

3. System according to claim 1, wherein the energy transmission line is a wave guide with a U shaped cross section, and wherein said wave guide is fitted so that the earth plane (5) closes off the wave guide space.

4. System according to claim 1, wherein the energy transmission line is a three plate line comprising a conductor line sandwiched between two three-plate line earth planes, and wherein wave radiation slots are made in the three-plate line earth plane that is in contact with said earth plane so that the slots of the earth plane (5) and the slots of the three-plate line are superposed.

5. System according to claim 1, wherein the energy transmission line is a three-plate line comprising a conductor line sandwiched between two three-plate line earth planes, and wherein one of the three-plate line earth planes is combined with said earth plane (5).

6. System according to claim 1, further comprising a plurality of linear sub-networks that are parallel to one another and wherein the slots (F₁-F₄) made in the earth plane (5) are positioned vertically to the power supply lines.

7. System according to claim 2 or claim 4, further comprising a plurality of linear sub-networks that are parallel to one another, wherein the slots (F₁-F₄) made in the earth plane (5) are positioned vertically to the power supply lines and wherein the slots made in the transmission line are notches made obliquely in the length of the transmission line.

8. System according to claim 1, wherein each power supply line is positioned with respect to the corresponding slot so as to control the coupling rate between the energy transmission line and said power supply line.

9. System according to claim 1, wherein each sub-network power supply line (b₁-b₄) comprises means of weighting the radiation amplitudes of the radiating elements (3) of the sub-network.

10. System according to claim 9, wherein the weighting means comprise impedance transformers (T) interspaced between the radiating elements (3).

11. System according to claim 1, wherein the size of the radiating elements (3) of a sub-network (b₁-b₄) is weighted so as to weight the radiation amplitudes of said radiating elements.

12. System according to claim 11, wherein the weighting of the size of a radiating element in the form of a conductive surface consists of reducing one of the characteristic dimensions of said surface.

13. System according to claim 1, wherein the power supply line of a sub-network of radiating elements is a micro-strip line.
